(19) United States
(12) Patent Application Publication
(10) Pub. No.: US 2009/0021648 A1
(43) Pub. Date: Jan. 22, 2009

(54) HISTOGRAM EQUALIZER AND HISTOGRAM EQUALIZATION METHOD

(75) Inventors: Beom Seok SHIN, Suwon-si (KR); Hyun Sang PARK, Cheonan-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/873,438

(22) Filed: Oct. 17, 2007

(30) Foreign Application Priority Data
Jul. 18, 2007 (KR) 10-2007-0071951

(51) Int. Cl. H04N 5/00

(52) U.S. Cl. 348/672; 348/E05.001

(57) ABSTRACT

A histogram equalizer and histogram equalization method is provided. A histogram equalizer, including: a memory; and an operation unit which reads first data and second data from the memory, and then overwrites the second data of the memory with a summed value, the summed value being obtained by summing the read first data and the read second data.

### CROSS-REFERENCE TO RELATED APPLICATION

This application claims priority from Korean Patent Application No. 10-2007-0071951, filed on Jul. 18, 2007, in the Korean Intellectual Property Office, the entire disclosure of which is incorporated herein by reference.

### BACKGROUND OF THE INVENTION

1. Field of the Invention

Methods and apparatuses consistent with the present invention relate to a histogram equalizer and histogram equalization method. More particularly, the present invention relates to a histogram equalizer and histogram equalization method used for performing of a histogram equalization which adaptively modifies a histogram indicating a distribution of video data to improve video data quality.

2. Description of Related Art

As portable devices such as cameras and camcoders have currently come into wide use due to rapid development of digital technologies, information including sounds, videos, and the like, may be used anytime and anywhere. Accordingly, a desire to improve video quality has been increased, and much research has been carried out to provide videos of superior quality to users.

Digital videos include artificial lighting or natural lighting, and video may not be recognizable due to inappropriate lighting intensity. A method of improving video quality which extends a dynamic range of brightness, that is, a range of brightness, has been studied.

One of the most widely used methods to increase a dynamic range of brightness is histogram equalization.

A histogram indicates a distribution of brightness with respect to pixels of digital video to provide a feature of video. Histogram equalization aims at generating a histogram including an extended distribution in comparison to a distribution prior to performing an equalization.

In histogram equalization, a mapping function is obtained using a histogram, and a dynamic range of brightness of a video prior to performing an equalization is adjusted by the mapping function. Accordingly, a video may include appropriately bright parts and dark parts, and thereby may improve video quality.

In this instance, a change of a dynamic range of brightness is proportional to a frequency of brightness in a video prior to performing an equalization.

Conventional researches to optimize a histogram equalization focus on developing algorithms used to convert video data through equalization. The developed algorithms are embodied in software, and focus on optimizing quality of video data after equalization.

Also, conventional researches were not focused on an embodiment of histogram equalization in hardware. However, currently, hardware embodiment of histogram equalization has become a focus of conventional researches due to the following two reasons. First, the number of pixels of portable video devices has been drastically increased due to development in technologies regarding portable video devices. Second, a number of bits for representing intensity of red, blue, and green colors has been increased up to more than eight bits due to developments in performance of image processors, and thus a size of video data required for a single pixel of video device increases.

Due to the above-described reasons, with respect to the embodiment of histogram equalization in hardware, an increase in storage space and an increase in a size of semiconductor, which were once considered insignificant, have become an issue when the histogram equalization is embodied as an integrated circuit on a semiconductor. Accordingly, a new embodiment of histogram equalization in hardware which may overcome the above disadvantages is required.

### SUMMARY OF THE INVENTION

The present invention provides a histogram equalizer and histogram equalization method, which may obtain a cumulative distribution required to perform histogram equalization, with a simple circuit configuration using relatively few registers.

Another aspect of the present invention also provides a histogram equalizer and histogram equalization method which may obtain a cumulative distribution required to perform histogram equalization by iteratively using a single data path.

According to an aspect of the present invention, there is provided a histogram equalizer, including: a memory; and an operation unit which reads first data and second data from the memory, and then overwrites the second data of the memory with a summed value, the summed value being obtained by summing the read first data and the read second data.

According to another aspect of the present invention, there is provided a histogram equalizer, including: a memory; a frequency distribution generation unit which overwrites the memory with an added value as frequency distribution data every time an address is externally inputted, the added value being obtained by adding 1 to a value of the data of the memory corresponding to the address; and a cumulative distribution generation unit which stores cumulative distribution data in the memory, the cumulative distribution data being obtained by sequentially reading each of the stored frequency distribution data and summing up the stored frequency distribution data.

According to another aspect of the present invention, there is provided a histogram equalization method, including: updating a value of data of a memory corresponding to an address and storing the updated value of data in the memory, every time the address is externally inputted; and storing cumulative distribution data in the memory, the cumulative distribution data being obtained by sequentially reading each of the updated data of the memory and summing up the read data.

According to the present invention, a cumulative distribution required to perform histogram equalization may be obtained with a simple circuit configuration using relatively few registers.

According to the present invention, a cumulative distribution required to perform histogram equalization may be obtained by iteratively using a single data path.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a diagram illustrating a histogram equalization operation according to an exemplary embodiment of the present invention;

FIG. 2 is a diagram illustrating a histogram before a histogram equalization operation is applied according to an exemplary embodiment of the present invention;

FIG. 3 is a diagram illustrating a histogram after a histogram equalization operation is applied according to an exemplary embodiment of the present invention;

FIG. 4 is a block diagram illustrating a histogram equalizer according to an exemplary embodiment of the present invention;

FIG. 5 is a diagram illustrating an operation unit of FIG. 4, in detail;

FIG. 6 is a block diagram illustrating a histogram equalizer according to another exemplary embodiment of the present invention;

FIG. 7 is a block diagram illustrating a histogram equalizer according to still another exemplary embodiment of the present invention;

FIG. 8 is a diagram illustrating an address control unit of FIG. 7, in detail;

FIG. 9 is a block diagram illustrating a histogram equalizer according to yet another exemplary embodiment of the present invention;

FIG. 10 is a flowchart illustrating a histogram equalization method according to an exemplary embodiment of the present invention; and

FIG. 11 is a timing diagram illustrating a histogram equalization method according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

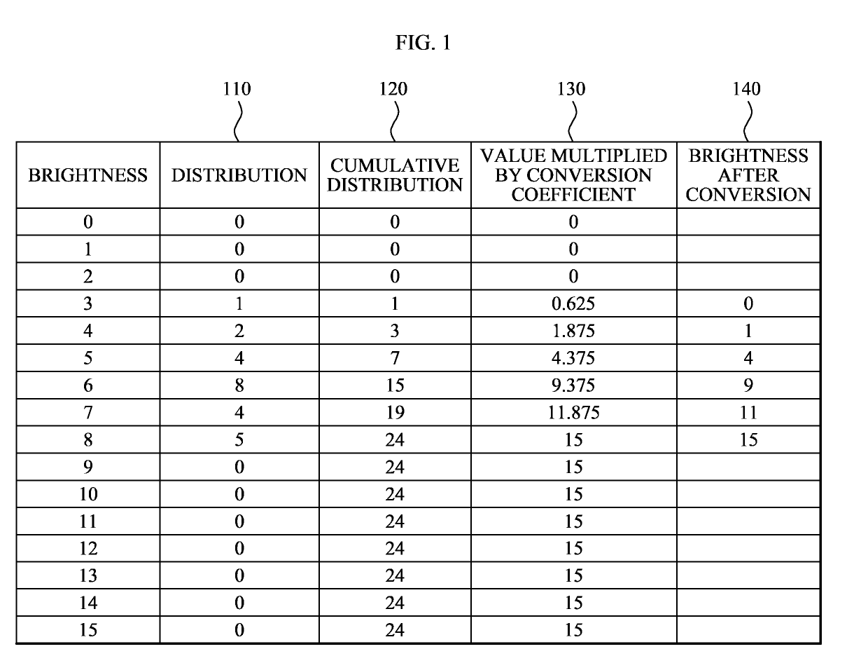

FIG. 1 is a diagram illustrating a histogram equalization operation according to an exemplary embodiment of the present invention.

Referring to FIG. 1, the histogram equalization operation relates to video data of 4×6 pixels from a screen. A brightness of the video data is from 0 to 15, and a cumulative distribution 120 is obtained by accumulating distributions 110 up to a corresponding brightness.

The distribution 110 indicates a number of times each brightness is shown on video data.

When a distribution with respect to a brightness i is x(i), a cumulative distribution with respect to the brightness i is c(i), which is represented as,

$$c ( i ) = {\sum }_{j = 0}^{i} x ( j ) . \qquad [ Equation 1 ]$$

Here, j is an index for the summation.

The histogram equalization operation generates a value multiplied by a conversion coefficient 130. The value multiplied by a conversion coefficient 130 is obtained by multiplying the cumulative distribution 120 by the conversion coefficient.

In this instance, the conversion coefficient is [a maximum value of brightness]/[a total number of pixels of the video data]. According to the present exemplary embodiment, the maximum value of brightness is 15, and the total number of pixels of the video data is 24.

The histogram equalization operation generates a brightness after a conversion 140 by taking only integer parts of the value multiplied by a conversion coefficient 130.

In this instance, the histogram equalization operation may calculate the brightness after a conversion 140 with respect to only brightness having the distribution 110 different from 0.

The histogram equalization operation may display the brightness after a conversion 140 by corresponding to the brightness on a screen. Since a brightness after a conversion 140 of a brightness 3 is 0, when a brightness of a pixel is 3, video data may be displayed on the screen by adjusting the brightness of the pixel to be 0. Similarly, since a brightness after a conversion 140 of a brightness 6 is 9, when a brightness of a pixel is 6, video data may be displayed on the screen by adjusting the brightness of the pixel to be 9.

A histogram distribution of the video data spreads by the above-described histogram equalization operation. Accordingly, video data which may be barely recognizable due to a low brightness may be easily converted to video data which may be easily recognizable, by the histogram equalization operation.

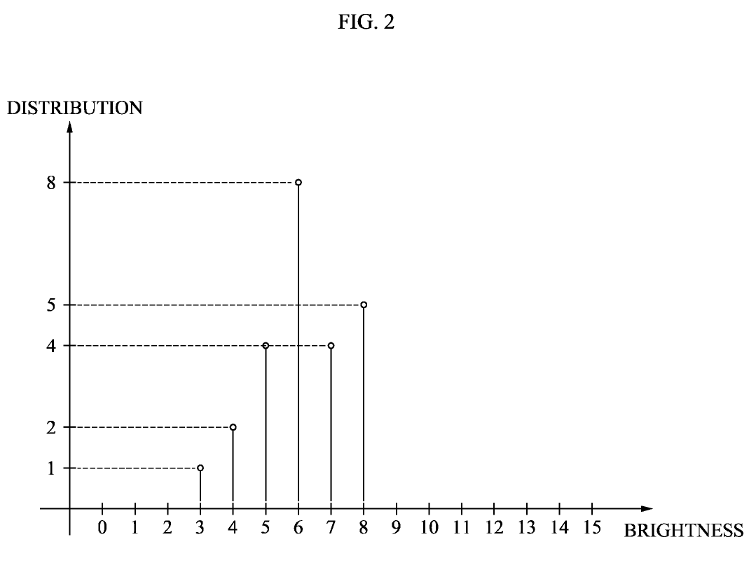

FIG. 2 is a diagram illustrating a histogram before a histogram equalization operation is applied according to an exemplary embodiment of the present invention.

Referring to FIG. 2, a horizontal axis of the histogram is a brightness, and a vertical axis of the histogram is a distribution 110.

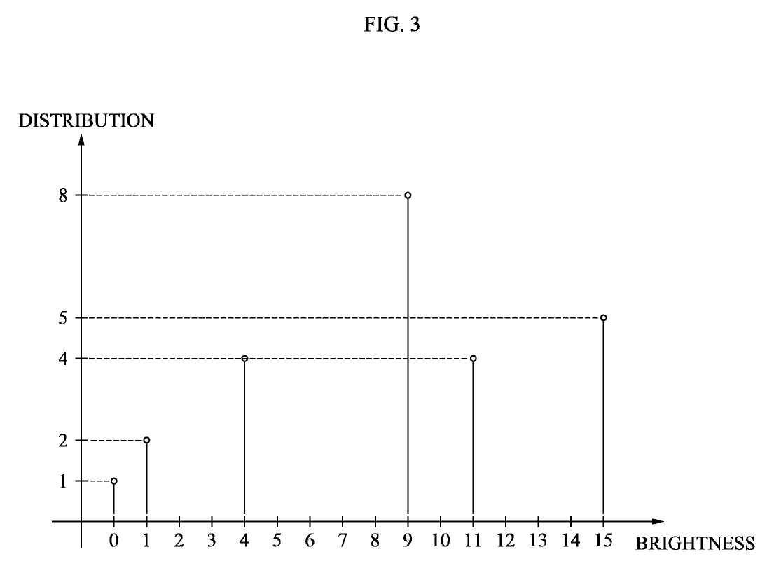

FIG. 3 is a diagram illustrating a histogram after a histogram equalization operation is applied according to an exemplary embodiment of the present invention.

Referring to FIG. 3, a horizontal axis of the histogram is a brightness after a conversion 140, and a vertical axis of the histogram is a distribution 110.

According to another embodiment of the present invention, a histogram equalization operation uses a probability density function (PDF) instead of a distribution corresponding to a brightness.

In this instance, a PDF y(i) corresponding to a brightness i is the same as a value which is obtained by dividing a distribution with respect to a brightness i x(i), by a total number of pixels n.

The histogram equalization operation uses a cumulative distribution function instead of a cumulative distribution. A cumulative distribution function corresponding to the brightness i is the same as a value which is obtained by summing up the PDF y(i).

According to still another embodiment of the present invention, a histogram equalization operation checks a distribution of a histogram brightness value.

The histogram equalization operation finds a lowest brightness value having a distribution different from 0, from the histogram.

The histogram equalization operation also finds a highest brightness value having a distribution different from 0, from the histogram.

The histogram equalization operation calculates a conversion coefficient for each brightness based on the lowest brightness value and highest brightness value.

The histogram equalization operation calculates a new brightness by multiplying the calculated conversion coefficient by each brightness of a pixel, and each pixel is displayed with respect to the new brightness.

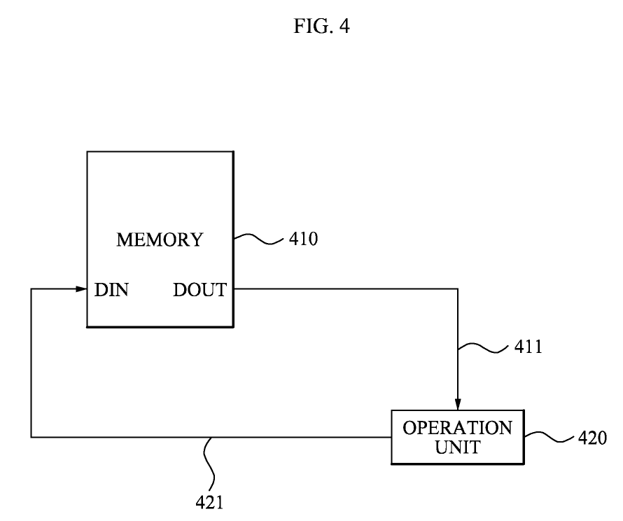

FIG. 4 is a block diagram illustrating a histogram equalizer according to an exemplary embodiment of the present invention.

Referring to FIG. 4, the histogram equalizer includes a memory 410 and an operation unit 420.

The operation unit 420 reads first data and second data via a path 411 from the memory 410. Also, the operation unit 420 overwrites the second data of the memory 410 with a summed value via a path 421. The summed value is obtained by summing the read first data and the read second data.

In this instance, the operation unit 420 may include a register. The register may store and maintain the first data. The operation unit 420 may sum the first data and the second data outputted from the register.

Also, the operation unit 420 may include a multiplexer. The multiplexer may, depending on a control signal, either output data having a value of 1, or output the first data.

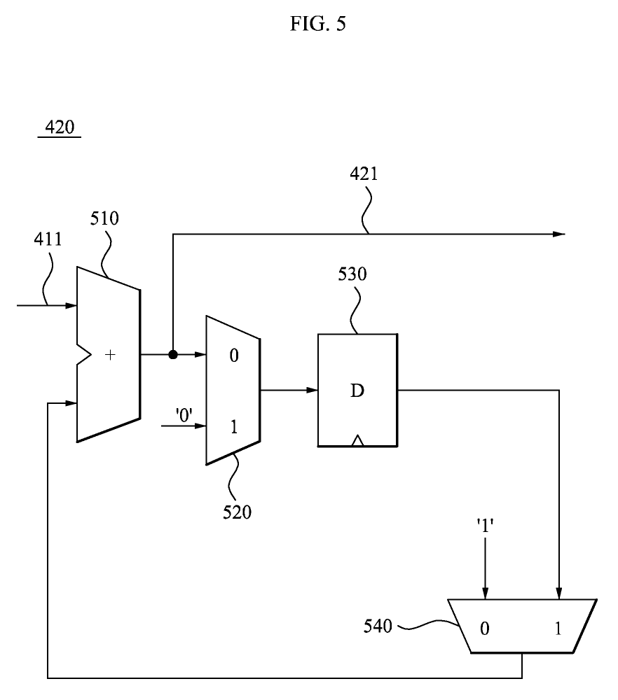

FIG. 5 is a diagram illustrating the operation unit 420 of FIG. 4, in detail.

Referring to FIG. 5, the operation unit 420 includes an adder 510, a multiplexer 520, a register 530, and another multiplexer 540.

The adder 510 sums output data of the other multiplexer 540, and data read from a memory 410 inputted via the path 411.

The multiplexer 520 selects any one of ‘0’ and output data of the adder 510, and outputs the selected data.

The register 530 operates with a system clock. Also, the register 530 stores and maintains output data of the multiplexer 520, and outputs the maintained data with a subsequent clock cycle.

The other multiplexer 540 selects any one of ‘1’ and output data of the register 530, and outputs the selected data.

When it is assumed that a control signal of the other multiplexer 540 and the multiplexer 520 is ‘0’, respectively, the multiplexer 520 transmits the output data of the adder 510 to the register 530. When it is assumed that the output data of the adder 510 is the first data, the register 530 stores the first data and outputs the stored first data with a subsequent clock cycle.

In the subsequent clock cycle, the register 530 outputs the first data, and the adder 510 reads the second data from the memory 410 via the path 411.

Since the multiplexer 540 transmits the output data of the register 530 to the adder 510, the adder 510 sums the first data received from the multiplexer 540 and the second data read from the memory 410 via the path 411, and overwrites the memory 410 with the summed value via the path 421.

In this instance, since an address of the memory 410 is an address corresponding to the second data, the operation unit 420 overwrites, via the path 421, the second data with a summed value which is obtained by summing the first data and the second data.

That is, the operation unit 420 reads the first data and the second data from the memory 410, and overwrites the second data of the memory 410 with the summed value via the path 421.

When it is assumed that the control signal of the other multiplexer 540 and the multiplexer 520 is ‘1’, respectively, the multiplexer 520 transmits ‘0’ to the register 530. Accordingly, the register 530 outputs ‘0’.

The other multiplexer 540 outputs ‘1’ to the adder 510 regardless of a value stored in the register 530. When it is assumed that the adder 510 reads third data from the memory 410 via the path 411, the adder 510 overwrites the memory 410 with an added value via the path 421. The added value is obtained by adding 1 to a value of the read third data.

In this instance, since an address of the memory 410 is an address corresponding to the third data, the adder 510 overwrites the third data of the memory 410 with the added value via the path 421.

That is, the operation unit 420 reads, via the path 411, the third data from the memory 410, and overwrites the third data with the added value via the path 421.

In this instance, the operation unit 420 may use ‘0’ for the control signal for each of the multiplexer 520 and the other multiplexer 540 in a first operation cycle. The operation unit 420 reads the first data and the second data from the memory 410 in the first operation cycle, and overwrites the second data of the memory 410 with the summed value.

In this instance, the operation unit 420 may use ‘1’ as the control signal of the other multiplexer 540 and the multiplexer 520, respectively. The operation unit 420 reads the third data from the memory 410 in a second operation cycle, and overwrites the third data of the memory 410 with the added value.

In this instance, the first operation cycle may be after the second operation cycle.

According to another exemplary embodiment, the operation unit 420 increments data, by one, corresponding to each address as many times as each address is inputted in the second operation cycle.

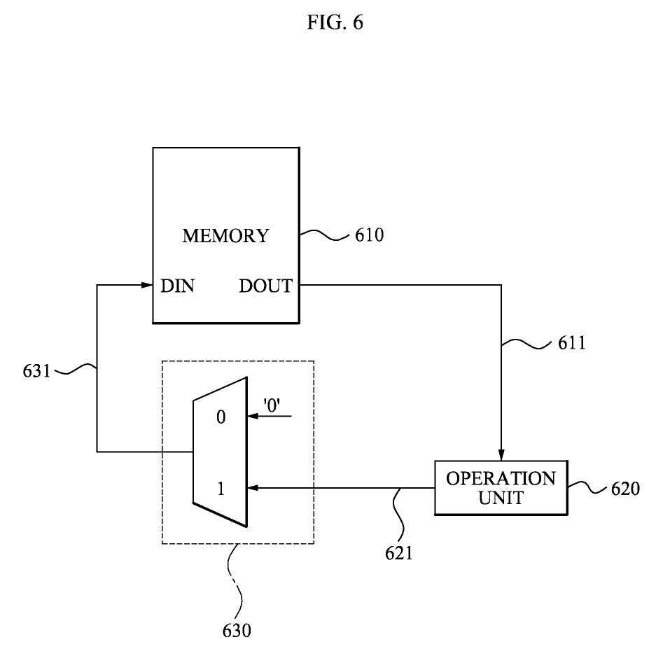

FIG. 6 is a block diagram illustrating a histogram equalizer according to another exemplary embodiment of the present invention.

Referring to FIG. 6, the histogram equalizer includes a memory 610, an operation unit 620, and a reset unit 630.

The reset unit 630 resets all data stored in the memory 610 while the operation unit 620 is idle. The reset unit 630 includes a multiplexer which selects any one of ‘0’ and output data of the operation unit 620 via a path 621 and outputs the selected value via a path 631. When a control signal of the multiplexer of the reset unit 630 corresponds to ‘0’, the multiplexer transmits ‘0’ to the memory 610.

The operation unit 620 reads all data stored in the memory 610 via a path 611 from the memory 610.

When the memory 610 sequentially changes an address from 0 to a maximum value, data corresponding to all addresses becomes ‘0’ and the memory 610 is reset.

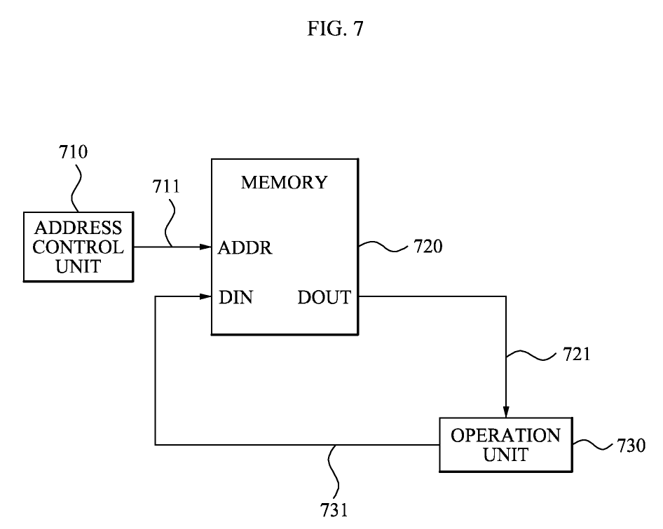

FIG. 7 is a block diagram illustrating a histogram equalizer according to still another exemplary embodiment of the present invention.

Referring to FIG. 7, the histogram equalizer includes an address control unit 710, a memory 720, and an operation unit 730.

The address control unit 710 sequentially generates all available addresses of the memory 720 and inputs all the available addresses in the memory 720 via a path 711 in a first operation cycle. Also, the address control unit 710 inputs an external address, externally inputted, in the memory 720 via the path 711 in a second operation cycle.

When the memory 720 receives the address via the path 711 from the address control unit 710, the memory 720 outputs data corresponding to the received address via a path 721 to the operation unit 730.

The operation unit 730 increments the data, by one, corresponding to each address of the memory 720 as many times as each address is inputted in the second operation cycle.

The address control unit 710 sequentially generates an address of the memory 720 from 0 to a maximum value in the first operation cycle. The operation unit 730 sums data corresponding to contiguous addresses of the memory 720, and overwrite a higher address of the adjacent addresses with a summed value in the first operation cycle via a path 731. In this instance, the data corresponds to two, and the summed value is obtained by summing the two data.

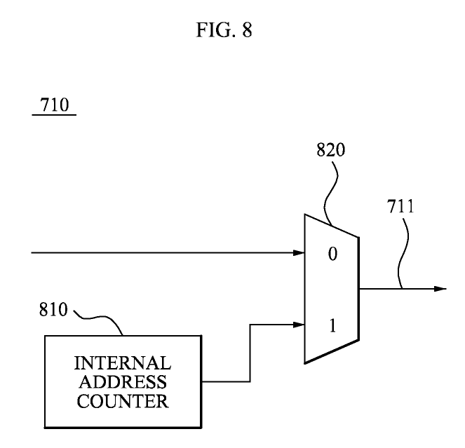

FIG. 8 is a diagram illustrating an address control unit of FIG. 7, in detail.

Referring to FIG. 8, the address control unit 710 includes an internal address counter 810 and a multiplexer 820.

A control signal of the multiplexer 820 is set to ‘1’ in a first operation cycle. The multiplexer 820 receives an address of the internal address counter 810, and transmits the address to a memory 720 via the path 711.

A control signal of the multiplexer 820 is set to ‘0’ in a second operation cycle. The multiplexer 820 transmits an external address to the memory 720 via the path 711.

The internal address counter 810 sequentially generates an address of the memory 720 from 0 to a maximum value of an address of the memory 720.

According to yet another exemplary embodiment of the present invention, a histogram equalizer may include a memory, an operation unit, and a histogram equalization unit.

The histogram equalization unit reads data from the memory, performs histogram equalization with respect to the data read from the memory, and outputs the histogram-equalized data.

In this instance, the performing of the histogram equalization includes multiplying the data read from the memory by a maximum value of an address, and dividing a result of the multiplication by a maximum value of the data.

In this instance, the data stored in the memory is video data. The performing of the histogram equalization includes multiplying the video data by a maximum value of brightness and dividing the result of the multiplication by a total number of pixels of the video data.

In this instance, the video data may include at least one of red, green, and blue color information data.

For example, when a brightness is represented with eight bits, a range of a value which may be a brightness value corresponds ‘0’ to ‘255’, and a maximum value of the brightness is 255. When video data corresponds to a 320×240 screen, a total number of pixels is 76800.

A single brightness may be a value obtained by averaging intensities of red, green, and blue color information data of video data. A histogram equalization may be separately performed with respect to each of the red, green, and blue color information data.

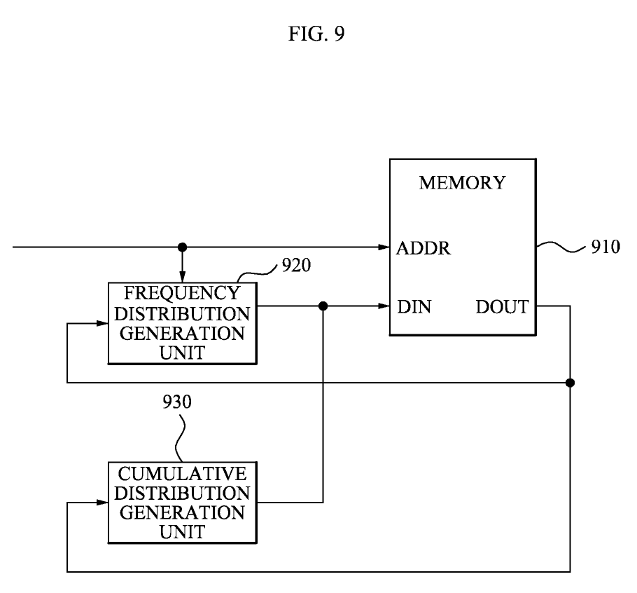

FIG. 9 is a block diagram illustrating a histogram equalizer according to yet another exemplary embodiment of the present invention.

Referring to FIG. 9, the histogram equalizer includes a memory 910, a frequency distribution generation unit 920, and a cumulative distribution generation unit 930.

The frequency distribution generation unit 920 overwrites the memory 910 with an added value as frequency distribution data every time an address is externally inputted. The added value is obtained by adding 1 to a value of the data of the memory 910 corresponding to the address.

When the frequency distribution generation unit 920 is operated in a predetermined operation cycle, for example, a second operation cycle, data which is stored in the memory 910 after the second operation cycle ends is the frequency distribution data corresponding to each address.

The cumulative distribution generation unit 930 stores cumulative distribution data in the memory 910. The cumulative distribution data is obtained by sequentially reading each of the stored frequency distribution data and summing up the stored frequency distribution data.

Since the data stored in the memory 910 is the frequency distribution data corresponding to each address after the second operation cycle ends, the cumulative distribution generation unit 930 sequentially reads each of the stored frequency distribution data and sums up the stored frequency distribution data.

In this instance, the cumulative distribution generation unit 930 sequentially reads first frequency distribution data and second frequency distribution data from the memory 910, and generates the cumulative distribution data by summing the first frequency distribution data and second frequency distribution data. The second frequency distribution data is subsequent to the first frequency distribution data. Also, the cumulative distribution generation unit 930 overwrites the second frequency distribution data with the generated cumulative distribution data of the memory 910.

A histogram equalizer may further include a reset unit which resets all data stored in the memory 910. The reset unit resets all the data stored in the memory 910 while the frequency distribution generation unit 920 and the cumulative distribution generation unit 930 are idle.

A histogram equalizer may further include a histogram equalization unit which performs histogram equalization with respect to the data read from the memory 910 and outputs the histogram-equalized data.

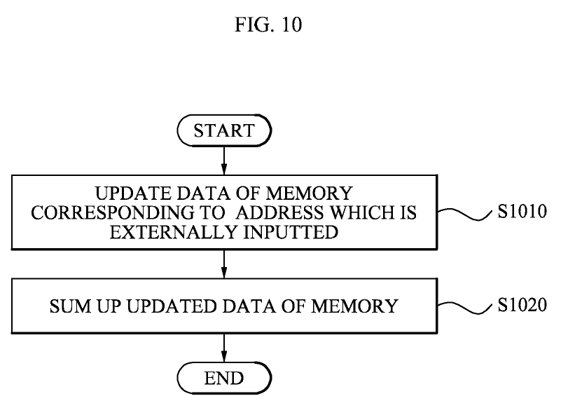

FIG. 10 is a flowchart illustrating a histogram equalization method according to an exemplary embodiment of the present invention.

Referring to FIG. 10, in operation S1010, the histogram equalization method updates a value of data of a memory corresponding to an address and stores the updated value of data in the memory, every time the address is externally inputted.

In operation S1020, the histogram equalization method stores cumulative distribution data in the memory. The cumulative distribution data is obtained by sequentially reading each of the updated data of the memory and summing up each of the updated data of the memory.

In operation S1020, the histogram equalization method sequentially reads first data and second data from the memory, sums the first data and the second data, and overwrites the second data with a summed value. The second data is subsequent to the first data, and the summed value is obtained by summing the first data and the second data.

The histogram equalization method may reset all the stored cumulative distribution data. Specifically, the histogram equalization method may reset all the stored cumulative distribution data, while operations S1010 and S1020 are not performed.

The histogram equalization method may perform histogram equalization with respect to the cumulative distribution data, and output the histogram-equalized data. The above-described operations or widely-known histogram equalization operation may be included in the histogram equalization method according to the present invention.

When the data stored in the memory is video data, the performing of the histogram equalization includes multiplying the video data by a maximum value of brightness and dividing a result of multiplication by a total number of pixels of the video data.

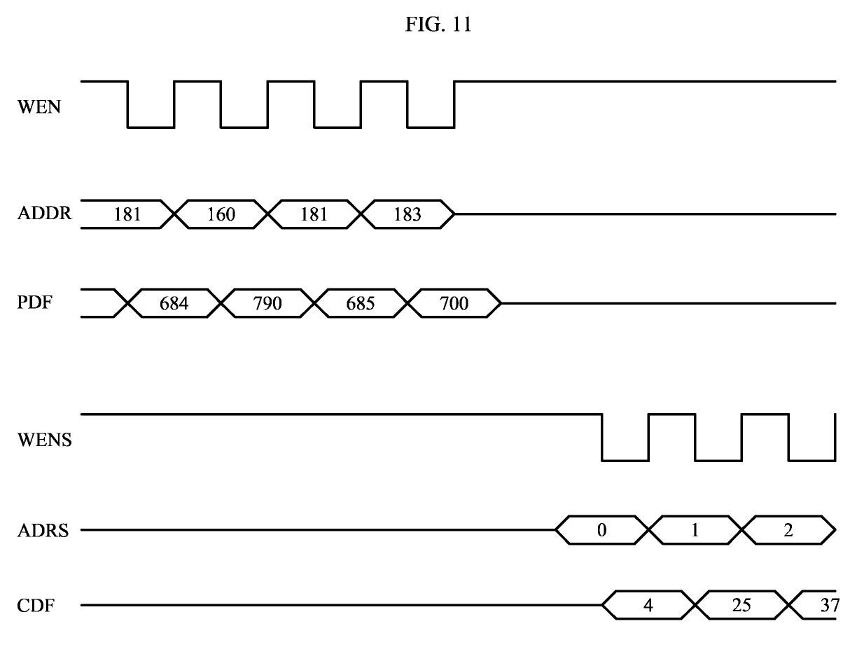

FIG. 11 is a timing diagram illustrating timing of a histogram equalization method according to an exemplary embodiment of the present invention.

Referring to FIG. 11, signal ‘WEN’ inputted to a memory controls a read/write operation of the memory.

Signal ‘ADDR’ is an address inputted in the memory.

When signal ‘WEN’ is ‘1’, an operation unit reads data corresponding to an address from the memory. When signal ‘WEN’ is ‘0’, an operation unit overwrites the address of the memory with the data.

Signal ‘PDF’ indicates probability density function. The operation unit outputs signal ‘PDF’, and overwrites the memory with signal ‘PDF’.

When signal ‘ADDR’ is ‘181’ in a first address period and signal ‘WEN’ is ‘0’, signal ‘PDF’ is ‘684’. Accordingly, signal ‘PDF’ of ‘684’ is stored in a location corresponding to ‘181’, that is, an address of the memory.

When signal ‘ADDR’ is ‘181’ in a third address period and signal ‘WEN’ is ‘1’, the operation unit reads the ‘684’ which is stored in the location corresponding to ‘181’, that is, the address of the memory.

When signal ‘WEN’ becomes ‘0’, the operation unit overwrites the location corresponding to ‘181’ with ‘685’. In this instance, the ‘685’ is obtained by adding 1 to the read ‘684’.

Signal ‘WENS’ is inputted to the memory and controls the read/write operation of the memory.

Signal ‘ADRS’ is an address inputted to the memory, and is sequentially generated by an internal address counter. The internal address counter sequentially generates an adjacent address.

Signal ‘CDF’ indicates a cumulative distribution function, and is data which is outputted from the operation unit and overwrites the memory.

When signal ‘ADRS’ is ‘0’ in a first sequential address period and signal ‘WENS’ is ‘0’, signal ‘CDF’ is ‘4’. Accordingly, signal ‘CDF’ of ‘4’ is stored in a location corresponding to ‘1’, that is, an address of the memory.

When signal ‘ADRS’ is ‘1’ in a second sequential address period signal ‘WENS’ is ‘1’, the operation unit reads ‘21’ which is stored in a location corresponding to ‘1’, that is, the address of the memory.

When signal ‘WENS’ becomes ‘0’, the operation unit overwrites the location corresponding to ‘1’ with ‘25’. In this instance, the ‘25’ is obtained by adding the read ‘21’ to ‘4’ which is read in a previous sequential address period, that is, the first sequential address period.

When signal ‘ADRS’ is ‘2’ in a third sequential address period and signal ‘WENS’ is ‘1’, the operation unit reads ‘12’ which is stored in a location corresponding to ‘2’, that is, an address of the memory.

When signal ‘WENS’ becomes ‘0’, the operation unit overwrites the location corresponding to ‘2’ with ‘37’. In this instance, the ‘37’ is obtained by adding the read ‘12’ to ‘25’ which is read in a previous sequential address period, that is, the second sequential address period.

According to an exemplary embodiment, distribution data may be used instead of signal ‘PDF’, and cumulative distribution data may be used instead of signal ‘CDF’.

According to an exemplary embodiment, the histogram equalization method may be embodied by using a state machine.

In the state machine, state S0 indicates an idle state,

State S1 indicates a memory initial state. All data of the memory is initialized prior to receiving valid data.

State S2 indicates a signal PDF generation state. In state S2, the histogram equalization method utilizes the received valid data as a read/write address of the memory.

After data corresponding to the read/write address is read from the memory, ‘1’ is added to the read data, and the read data of the memory is overwritten with the added value.

State S3 indicates a signal CDF generation state. When a transmission of the available data is completed, the data stored in the memory is sequentially read, accumulates a value of previous address, and thereby may generate signal CDF.

The state machine generates a flag signal indicating each of the four states, that is, state S0, state S1, state S2, and state S3. When a condition which causes a transition from a current state to a subsequent state is satisfied, the transition is performed and the flag signal is set to correspond to the transition.

The histogram equalization method according to the above-described exemplary embodiments may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, there is provided a histogram equalizer and histogram equalization method, which may obtain a cumulative distribution required to perform histogram equalization, with a simple circuit configuration using relatively few registers.

Also, according to the present invention, there is provided a histogram equalizer and histogram equalization method which may obtain a cumulative distribution required to perform histogram equalization by iteratively using a single data path.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A histogram equalizer, comprising:
a memory; and
an operation unit which reads first data and second data from the memory, and then overwrites the second data of the memory with a summed value, the summed value being obtained by summing the read first data and the read second data.

2. The histogram equalizer of claim 1, wherein the operation unit reads third data from the memory, and then overwrites the third data with an added value, the added value being obtained by adding 1 to a value of the read third data.

3. The histogram equalizer of claim 2, wherein the operation unit reads the first data and the second data and then overwrites the second data with the summed value in a first operation cycle, and reads the third data from the memory and then overwrites the third data with the added value in a second operation cycle.

4. The histogram equalizer of claim 3, wherein the first operation cycle is after the second operation cycle.

5. The histogram equalizer of claim 3, further comprising:
an address control unit which sequentially generates all available addresses of the memory and inputs all the available addresses in the memory in the first operation cycle, and inputs an external address, externally inputted, in the memory in the second operation cycle.

6. The histogram equalizer of claim 1, further comprising:
a reset unit which resets all data stored in the memory while the operation unit is idle.

7. The histogram equalizer of claim 1, further comprising:
a histogram equalization unit which reads data from the memory, performs histogram equalization with respect to the data read from the memory, and outputs the histogram-equalized data.

8. The histogram equalizer of claim 7, wherein the performing of the histogram equalization includes multiplying the data read from the memory by a maximum value of an address, and dividing a result of multiplication by a maximum value of the data.

9. The histogram equalizer of claim 7, wherein the data stored in the memory is video data, and the performing of the histogram equalization includes multiplying the video data by a maximum value of brightness and dividing a result of multiplication by a total number of pixels of the video data.

10. The histogram equalizer of claim 9, wherein the video data includes at least one of red, green, and blue color information data.

11. The histogram equalizer of claim 2, wherein the operation unit comprises a multiplexer which, depending on a control signal, either outputs data having a value of 1, or outputs the first data.

12. The histogram equalizer of claim 1, wherein the operation unit comprises a register which stores and maintains the first data, and outputs the maintained first data to be summed to the second data.

13. A histogram equalizer, comprising:
a memory;
a frequency distribution generation unit which overwrites the memory with an added value as frequency distribution data every time an address is externally inputted, the added value being obtained by adding 1 to a value of the data of the memory corresponding to the address; and
a cumulative distribution generation unit which stores cumulative distribution data in the memory, the cumulative distribution data being obtained by sequentially reading each of the stored frequency distribution data and summing up the stored frequency distribution data.

14. The histogram equalizer of claim 13, wherein the cumulative distribution data is obtained by summing first frequency distribution data and second frequency distribution data which are sequentially read, and then the cumulative distribution generation unit overwrites the second frequency distribution data with the generated cumulative distribution data.

15. The histogram equalizer of claim 13, further comprising:
a reset unit which resets all data stored in the memory.

16. The histogram equalizer of claim 13, further comprising:
a histogram equalization unit which performs histogram equalization with respect to the data read from the memory and outputs the histogram-equalized data.

17. A histogram equalization method, comprising:
updating a value of data of a memory corresponding to an address and storing the updated value of data in the memory, every time the address is externally inputted; and
storing cumulative distribution data in the memory, the cumulative distribution data being obtained by sequentially reading each of the updated data of the memory and summing up the read data.

18. The histogram equalization method of claim 17, wherein the storing sequentially reads first data and second data from the memory, the second data being subsequent to the first data, sums the first data and the second data, and overwrites the second data with a summed value.

19. The histogram equalization method of claim 17, further comprising:
resetting all the stored cumulative distribution data.

20. The histogram equalization method of claim 17, further comprising:
performing histogram equalization with respect to the cumulative distribution data, and outputting the histogram-equalized data.

21. The histogram equalization method of claim 20, wherein the data stored in the memory is video data, and the performing of the histogram equalization includes multiplying the video data by a maximum value of brightness and dividing a result of multiplication by a total number of pixels of the video data.

22. A computer-readable recording medium storing a program for implementing a histogram equalization method, comprising:
updating a value of data of a memory corresponding to an address and storing the updated value of data in the memory, every time the address is externally inputted; and
storing cumulative distribution data in the memory, the cumulative distribution data being obtained by sequentially reading each of the updated data of the memory and summing up the read data.
